(19) United States
(12) Patent Application Publication
(10) Pub. No.: US 2025/0173671 A1
(43) Pub. Date: May 29, 2025

(54) ARTIFICIAL INTELLIGENCE WAREHOUSE MANAGEMENT TRANSSHIPMENT SYSTEM

(71) Applicants: Zhen-Sheng Wang, SANTA FE SPRINGS, CA (US); Ze-Nong Wang, SANTA FE SPRINGS, CA (US); Ze-Feng Wang, SANTA FE SPRINGS, CA (US)

(72) Inventors: Zhen-Sheng Wang, SANTA FE SPRINGS, CA (US); Ze-Nong Wang, SANTA FE SPRINGS, CA (US); Ze-Feng Wang, SANTA FE SPRINGS, CA (US)

(21) Appl. No.: 18/522,274

(22) Filed: Nov. 29, 2023

(51) Int. Cl. G06Q 10/087; G06Q 10/0835

(52) U.S. Cl. CPC G06Q 10/087; G06Q 10/08355

(57) ABSTRACT

The present invention provides an artificial intelligence warehouse management transshipment system, including a transshipment goods unit, a terminal unit, a data transmission unit and a management unit. The management unit has an artificial intelligence computing unit and a transshipment order integration unit. The data transmission unit sends the content of the transshipment goods unit acquired by an acquiring unit of the terminal unit to the artificial intelligence computing unit. After artificial intelligence computation, the artificial intelligence computing unit generates a plurality of transshipment orders each corresponding to each batch of transshipment goods. The transshipment order integration unit can consolidate related ones of the plurality of transshipment orders into a single delivery order. Through the delivery order, the transshipment goods with the same attributes can be loaded into the same container and transported in the same trip, eliminating the need for round-trip delivery.

### BACKGROUND OF THE INVENTION

### Fields of the Invention

The present invention relates to a technical field of warehouse management and, more particularly to an artificial intelligence warehouse management transshipment system.

### Descriptions of Related Art

With the increasing market competition and the rapid development of international trade, many businesses are beginning to focus on the efficiency of warehouse management.

Existing warehouse management often involves transshipment of goods during the logistics process, resulting in a large number of transshipment orders. These transshipment orders cover a variety of items, each with different content, and clients have high requirement on transshipment. Therefore, warehouse management systems are required to have higher efficiency in transshipment. If transshipment orders are not processed promptly or if issues such as missing transshipment goods occur during the transshipment process, client satisfaction will decrease. However, existing warehouse management systems do not have effective solutions to these problems. Therefore, developing an artificial intelligence warehouse management transshipment system that can improve work efficiency and reduce operating costs is crucial for businesses and becomes one of the primary research topics of the present invention.

### SUMMARY OF THE INVENTION

The primary objective of the present invention is to utilize an artificial intelligence warehouse management transshipment system to consolidate transshipment orders with related attributes of transshipment goods into a single delivery order, thereby improving the efficiency of goods transshipment.

To achieve the above objectives, the present invention provides an artificial intelligence warehouse management transshipment system, including a transshipment goods unit, a terminal unit, a data transmission unit and a management unit. The management unit has an artificial intelligence computing unit and a transshipment order integration unit. The data transmission unit can send the content of the transshipment goods unit acquired by an acquiring unit of the terminal unit to the artificial intelligence computing unit. After artificial intelligence computation, the artificial intelligence computing unit generates a plurality of transshipment orders each corresponding to each batch of transshipment goods. The transshipment order integration unit can consolidate related ones of the plurality of transshipment orders into a single delivery order. Through the delivery order, the transshipment goods with the same attributes can be loaded into the same container and transported in the same trip, eliminating the need for round-trip delivery.

In the present invention, the system further includes a storage unit for storing the delivery order of the management unit.

In the present invention, the transshipment goods inbound information includes transshipment goods inbound date, transshipment goods inbound type, and transshipment goods volume.

In the present invention, the transshipment goods storage bin information includes transshipment goods storage bin quantity and transshipment storage bin location.

In the present invention, the transshipment goods outbound information includes transshipment goods outbound date, transshipment goods outbound type, transshipment goods outbound volume, and transshipment goods shipping address.

In the present invention, the terminal unit can be a multimedia mobile device, and the multimedia mobile device can be a personal digital assistant (PDA), phone, or tablet.

### BRIEF DESCRIPTION OF THE DRAWINGS

FIG. 1 is a system block diagram of the present invention.

FIG. 2 is a block diagram of a transshipment goods unit of the present invention.

FIG. 3 is a block diagram of transshipment goods inbound information of the present invention.

FIG. 4 is a block diagram of transshipment goods storage bit information of the present invention.

FIG. 5 is a block diagram of transshipment goods outbound information of the present invention.

FIG. 6 is a block diagram of transshipment goods shipping address of the present invention.

### DETAILED DESCRIPTION OF THE PREFERRED EMBODIMENT

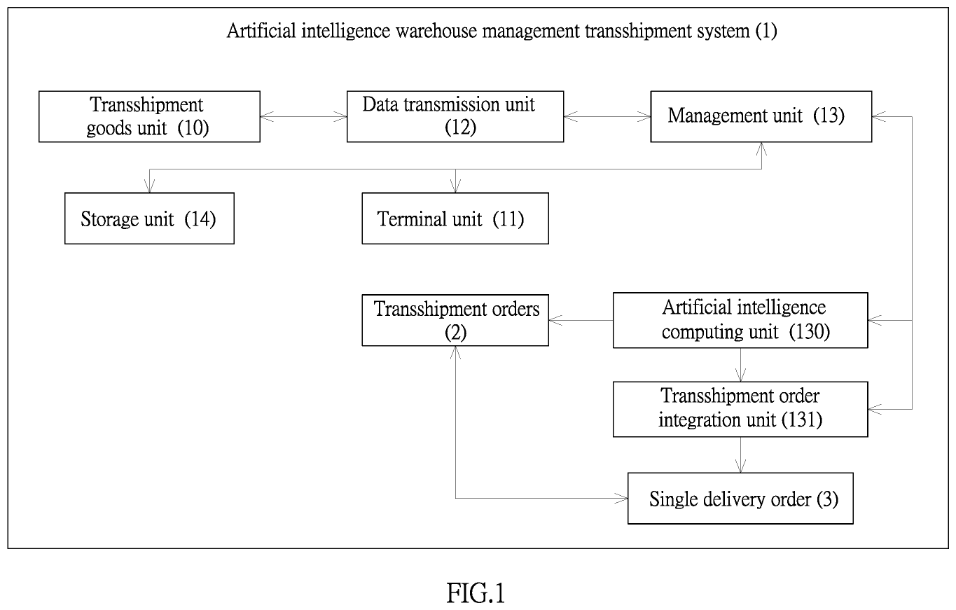

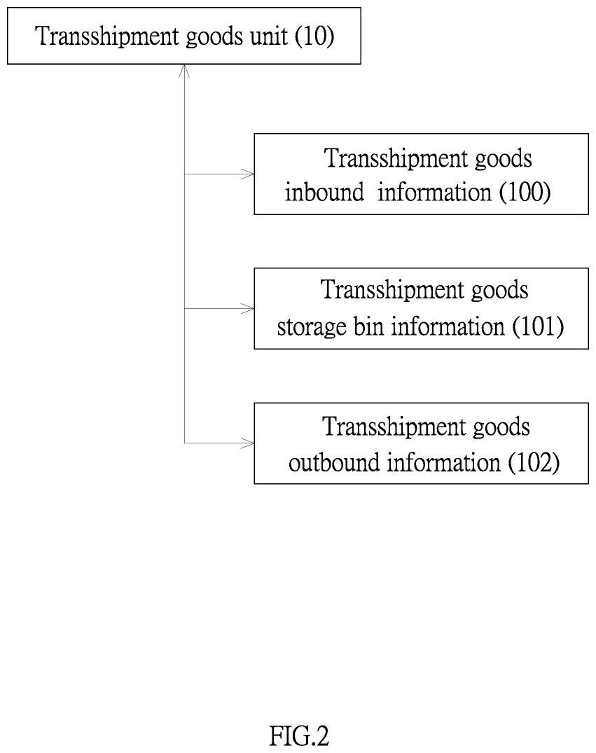

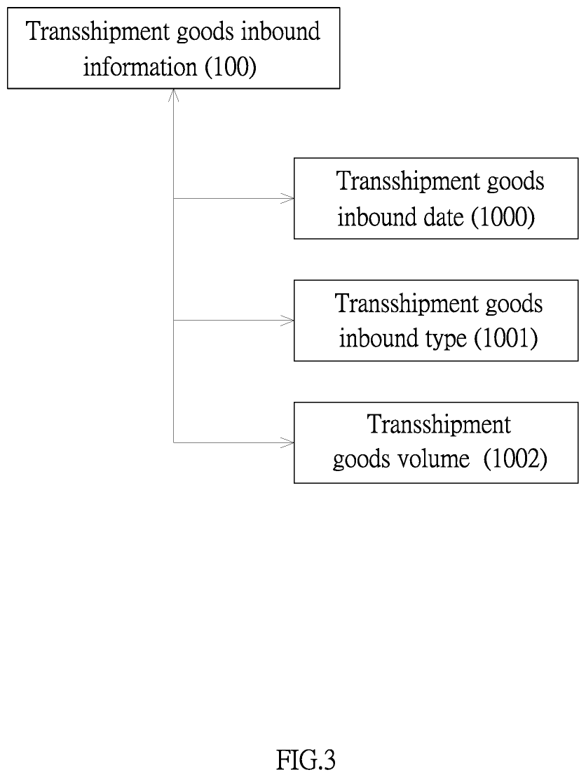

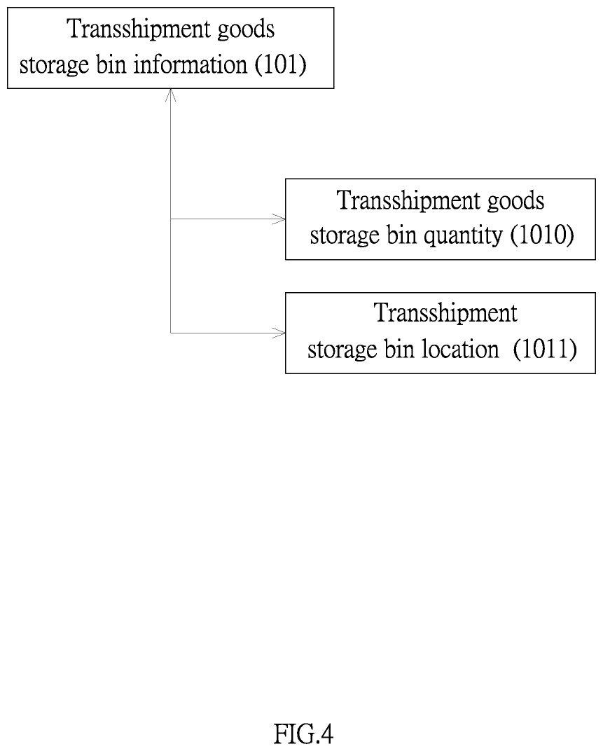

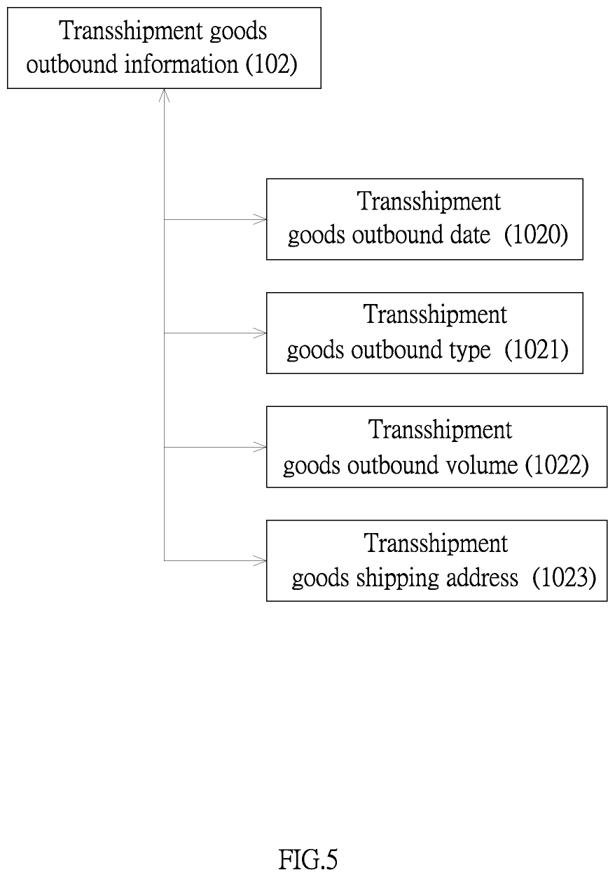

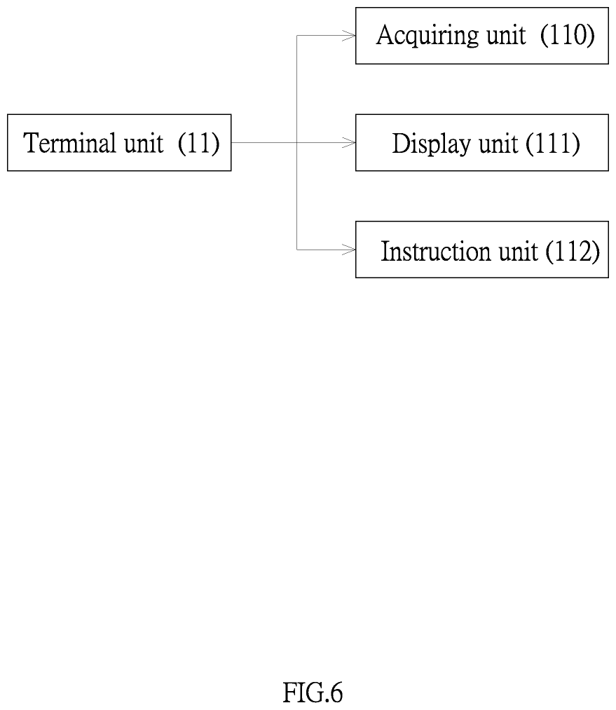

As shown in FIGS. 1 to 6, the present invention provides an artificial intelligence warehouse management transshipment system 1, comprising a transshipment goods unit 10, a terminal unit 11, a data transmission unit 12, a management unit 13, and a storage unit 14 in mutual connection.

The transshipment goods unit 10 corresponds to each batch of transshipment goods and has transshipment goods inbound information 100, transshipment goods storage bin information 101, and transshipment goods outbound information 102. The transshipment goods inbound information 100 includes transshipment goods inbound date 1000, transshipment goods inbound type 1001, and transshipment goods volume 1002. The transshipment goods storage bin information 101 includes transshipment goods storage bin quantity 1010 and transshipment storage bin location 1011. The transshipment goods outbound information 102 includes transshipment goods outbound date 1020, transshipment goods outbound type 1021, transshipment goods outbound volume 1022, and transshipment goods shipping address 1023. In this embodiment, the transshipment goods unit 10 can be an RFID electronic tag.

The terminal unit 11 has an acquiring unit 110, a display unit 111, and an instruction unit 112 in mutual connection. The acquiring unit 110 is used to acquire the content of the transshipment goods unit 10 from each batch of transshipment goods and display it on the display unit 111. The instruction unit 112 allows warehouse personnel to determine whether the content displayed on the display unit 111 is correct. If correct, a confirmation command is entered. In this embodiment, the terminal unit 11 can be a multimedia mobile device, such as a personal digital assistant (PDA), phone, or tablet. Additionally, the terminal unit 11 can be used by warehouse personnel or clients.

The data transmission unit 12 receives the content of the transshipment goods unit 10 of each batch of transshipment goods acquired by the terminal unit 11 and enables transmission in wireless or wired manner.

The management unit 13 has an artificial intelligence computing unit 130 and a transshipment order integration unit 131. The data transmission unit 12 sends the content of each batch of transshipment goods acquired by the acquiring unit 110 to the artificial intelligence computing unit 130. The artificial intelligence computing unit 130 comprehensively computes the content of the transshipment goods unit 10 in an AI-based manner and generates a plurality of transshipment orders 2 each corresponding to each batch of transshipment goods. The transshipment order integration unit 131 then consolidates multiple transshipment orders 2 with related goods content into a single delivery order 3, allowing goods with associated content to be loaded into the same container and shipped together.

The storage unit 14 is used to store the content of all the delivery orders 3 from the management unit 13.

The application of the system is further explained. Warehouse personnel use the acquiring unit 110 of the terminal unit 11 (e.g., PDA, phone, tablet) to acquire the transshipment goods unit 10 of each batch of transshipment goods by scanning or photographing. The content of the transshipment goods is displayed on the display unit 111 for the warehouse personnel to determine. If the warehouse personnel agree with the content displayed on the display unit 111, a confirmation command can be entered through the instruction unit 112 to the terminal unit 11 and the artificial intelligence computing unit 130. Then, the display unit 111 of the terminal unit 11 would display the corresponding transshipment storage bin location 1011 for each batch of transshipment goods in the warehouse. In the meanwhile, the artificial intelligence computing unit 130 generates the transshipment orders 2 each corresponding to each batch of transshipment goods. Subsequently, through the transshipment order integration unit 131, a plurality of transshipment orders 2 with related content are consolidated into a single delivery order 3. Therefore, for a large quantity of transshipment goods, by consolidating the transshipment orders 2 of the plural transshipment goods with the same attributes into a single delivery order 3, the driver can load the transshipment goods with the same attributes into the same container and arrange a trip for uniform delivery of them based on the content of the delivery order 3, without wasting time traveling back and forth for the same transshipment goods.

In addition, the terminal unit 11 can be used not only by warehouse personnel but also by clients. Clients can use the display unit 111 of the terminal unit 11 to review individual delivery orders 3 for their transshipment goods, and track the specific status of the transshipment goods.

It is worth noting that when there is an emergency in the warehouse or warehouse personnel do not agree with the recommended transshipment storage bin location 1011 displayed on the display unit 111, the system can also be switched into a manual mode. The warehouse personnel can then manually choose the transshipment storage bin location 1011 based on the current warehouse situation. The system's flexibility in switching to a manual mode avoids delays in warehouse operations when the system fails, significantly improving operational efficiency.

In summary, the artificial intelligence warehouse management transshipment system 1 provided by the present invention can consolidate plural transshipment orders 2 with the same shipping attributes into a single delivery order 3. For a large quantity of transshipment goods, this allows the driver to transport transshipment goods with the same route at once, improving shipping efficiency. The transshipment orders generated by the artificial intelligence system can reduce error rates and increase the speed of data processing and operational procedures.

What is claimed is:

1. An artificial intelligence warehouse management transshipment system, comprising: a transshipment goods unit, a terminal unit, a data transmission unit and a management unit in mutual connection, wherein
the transshipment goods unit corresponds to each batch of transshipment goods and has transshipment goods inbound information, transshipment goods storage bin information, and transshipment goods outbound information;
the terminal unit has an acquiring unit, a display unit, and an instruction unit in mutual connection, wherein the acquiring unit is configured to acquire and display content of the transshipment goods unit from the each batch of transshipment goods on the display unit, and wherein the instruction unit enables warehouse personnel to determine whether the content displayed on the display unit is correct, and if correct, the instruction unit allows for entering a confirmation command and causes a transshipment storage bin location corresponding to the each batch of transshipment goods in a warehouse to be displayed on the display unit;
the data transmission unit is configured to receive and transmit wirelessly or wiredly the content of the transshipment goods unit acquired by the terminal unit; and
the management unit has an artificial intelligence computing unit and a transshipment order integration unit, wherein after the data transmission unit sends the content of the transshipment goods unit acquired by the acquiring unit to the artificial intelligence computing unit, the artificial intelligence computing unit generates a plurality of transshipment orders each corresponding to the each batch of transshipment goods after artificial intelligence computation, and then the transshipment order integration unit consolidates related ones of the plurality of transshipment orders into a single delivery order.

2. The artificial intelligence warehouse management transshipment system as claimed in claim 1, further comprising a storage unit for storing the delivery order.

3. The artificial intelligence warehouse management transshipment system as claimed in claim 1, wherein the transshipment goods inbound information includes transshipment goods inbound date, transshipment goods inbound type, and transshipment goods volume.

4. The artificial intelligence warehouse management transshipment system as claimed in claim 1, wherein the transshipment goods storage bin information includes transshipment goods storage bin quantity and transshipment storage bin location.

5. The artificial intelligence warehouse management transshipment system as claimed in claim 1, wherein the transshipment goods outbound information includes transshipment goods outbound date, transshipment goods outbound type, transshipment goods outbound volume, and transshipment goods shipping address.

6. The artificial intelligence warehouse management transshipment system as claimed in claim 1, wherein the terminal unit is a multimedia mobile device.

7. The artificial intelligence warehouse management transshipment system as claimed in claim 6, wherein the multimedia mobile device is a personal digital assistant (PDA), phone, or tablet.

8. The artificial intelligence warehouse management transshipment system as claimed in claim 1, wherein the terminal unit allows for being used by warehouse personnel or clients.

9. The artificial intelligence warehouse management transshipment system as claimed in claim 1, wherein the data transmission unit enables wireless or wired transmission.
